(19) United States
(12) Patent Application Publication
(10) Pub. No.: US 2015/0103461 A1
(43) Pub. Date: Apr. 16, 2015

(54) SURGE PROTECTOR HAVING IMPROVED I-SHAPED LOAD STRUCTURE

(71) Applicant: SURGE LAB KOREA CO., LTD., Daejeon (KR)

(72) Inventor: Seon-Ho Kim, Daejeon (KR)

(73) Assignee: SURGE LAB KOREA CO., LTD., Daejeon (KR)

(21) Appl. No.: 14/080,360

(22) Filed: Nov. 14, 2013

(30) Foreign Application Priority Data
Oct. 15, 2013 (KR) 10-2013-0122456

(51) Int. Cl. H02H 9/00

(52) U.S. Cl. CPC H02H 9/005
USPC 361/118

(57) ABSTRACT

Provided is a surge protector having an improved I-shaped load structure. The surge protector includes an outside conductor provided with input and output terminals on both sides thereof, an input terminal configured such that a high frequency signal is input from the outside thereto, an output terminal configured such that a high frequency signal is output therefrom, an inside conductor disposed inside the outside conductor to electrically connect the input and output terminals to each other, and an I-shaped load configured such that a lower end thereof is connected from a center of the outside conductor to the inside conductor and an upper end thereof is connected to the outside conductor. A dielectric partition is formed to have a predetermined height in a direction from the bottom of the I-shaped load to the top thereof.

### CROSS REFERENCE

Applicant claims foreign priority under Paris Convention and 35 U.S.C. §119 to Korean Patent Application No. 10-2013-0122456, filed 15 Oct. 2013, with the Korean Intellectual Property Office, where the entire contents are incorporated herein by reference.

### BACKGROUND OF THE INVENTION

1. Field of the Invention

The present invention relates generally to a surge protector and, more particularly, to a technology that is capable of considerably reducing the length of an I-shaped short-circuit load that is connected to the inside conductor of a surge protector for a coaxial cable and discharges a surge frequency signal through a grounded outside conductor.

2. Description of the Related Art

Generally, in balanced lines, the characteristic impedances of two lines are the same, and thus the amounts of energy induced to the two lines are the same even when they are exposed to a lightning surge. Accordingly, damage attributable to a lightning surge acting between the lines is not great, but a lightning surge voltage acting between the lines and ground is problematic.

In contrast, in unbalanced lines such as a coaxial cable, the characteristic impedances of an inside conductor and an outside conductor are not the same, and thus the amounts of energy induced to the two lines are not the same when they are exposed to a lightning surge. Accordingly, damage attributable to a lightning surge acting between the lines is relatively great.

Therefore, surge protective devices (SPDs) that limit an excessive voltage attributable to a lightning surge and discharge a surge current are widely used.

In RF theory, L-shaped resonant filters are known as filters for blocking specific frequency components. Two types of L-shaped resonant filters are illustrated in FIG. 1A and FIG. 1B.

L-shaped resonant filters are filters that include a primary line 100 and an L-shaped load 110 spaced apart from the primary line 100 by a predetermined distance and configured such that a vertical line 111 and a lateral line 112 are connected in an L shape. FIG. 1A illustrates an L-shaped resonant filter in which the upper end of the vertical line 111 of an L-shaped load 110 is open and a vertical line 111 and a lateral line 112 are each formed to have a length of ½λ. In contrast, FIG. 1b illustrates an L-shaped resonant filter in which the upper end of the vertical line 111 of an L-shaped load 110 is short-circuited and a vertical line 111 and a lateral line 112 are formed to have a length of ¼λ and a length of ½λ, respectively.

Such an L-shaped resonant filter is a kind of band stop filter, and may be configured to allow an L-shaped load to have a length that causes resonance in conjunction with a frequency required to be filtered out and to thereby attenuate a signal of the frequency required to be filtered out.

Meanwhile, such L-shaped resonant filters are known to be excellent in terms of filter performance with respect to signals having general strengths.

Since a surge is composed of specific frequency components, the use of an L-shaped resonant filter as a surge protector may be taken into consideration. However, a surge has the characteristic of a large amount of energy, and thus sufficient attenuation cannot be achieved only with resonance, with the result that the problem in which surge frequencies of 20 KHz to 20 MHz cannot be filtered out, occurs, unlike in theory.

Furthermore, assuming that the center frequency of a surge is 1 MHz, λ=c/f=3×10⁸/10⁶=300 m in order to resonate with the center frequency of the surge. Even when the vertical line 111 of the L-shaped load has a length of ¼λ, the length thereof is 75 m, which is very long. Accordingly, the problem of actual implementation being difficult occurs.

Therefore, a surge protector has been proposed that has the characteristic of a band pass filter that only passes a signal in a desired frequency band because an I-shaped load composed of only a vertical line is used in an L-shaped resonant filter.

FIG. 2 illustrates an example of a surge protector using a conventional I-shaped load structure. Referring to FIG. 2, the surge protector using a conventional I-shaped load structure includes input and output terminals 101 and 102 disposed on both sides of a housing 105 and configured to connect with a coaxial cable, equipment or the like, a primary line 103 configured to electrically connect the input and output terminals to each other, and an I-shaped load 104 connected to the housing 105 at an end thereof and configured to pass through the center of the housing 105. A space around the I-shaped load 104 is filled with air.

The surge protector using a conventional I-shaped load structure has the characteristic of resonating with a desired frequency and thus passing only the corresponding frequency and suppressing signals in the other frequency bands. If the desired frequency band is 100 MHz and the length of the I-shaped load 104 is λ, λ=c/f=3×10⁸/10⁸=3 m. Accordingly, the surge protector has the advantage of achieving a shorter load length than that of the L-shaped resonant filter, but has the disadvantage of the length being still too long to be applied to actual surge protectors.

In order to reduce the length of the I-shaped load 104, the length of the I-shaped load 104 can be shortened using the characteristics of achieving a 1 wavelength effect with a ¼ wavelength and achieving a ½ wavelength effect with a ⅛ wavelength.

When the I-shaped load 104 has a length of ¼λ, a length of ⅛λ and a length of 1/16λ, the length thereof can be reduced to 75 cm, 37.5 cm, and 18.75 cm, respectively.

However, when the I-shaped load 104 is implemented based on a short wavelength, the disadvantage of insertion loss occurs.

In another conventional technology, in order to reduce the protruding height of an I-shaped load while reducing insertion loss, the I-shaped load is configured in a coil form, but it is limited in the reduction of the protruding height of the I-shaped load to a sufficient length.

### SUMMARY OF THE INVENTION

Accordingly, the present invention has been made keeping in mind the above problems occurring in the prior art, and an object of the present invention is to considerably reduce the length of an I-shaped load by filling a space between the end of the I-shaped load and a ground with a ferroelectric substance, thereby providing the effect of extending the load, which is proportional to a dielectric constant.

In accordance with an aspect of the present invention, there is provided a surge protector having an improved I-shaped load structure, including an outside conductor provided with input and output terminals on both sides thereof; an input terminal configured such that a high frequency signal is input from the outside thereto; an output terminal configured such that a high frequency signal is output therefrom; an inside conductor disposed inside the outside conductor to electrically connect the input and output terminals to each other; and an I-shaped load configured such that a lower end thereof is connected from a center of the outside conductor to the inside conductor and an upper end thereof is connected to the outside conductor; wherein a dielectric partition is formed to have a predetermined height in a direction from the bottom of the I-shaped load to the top thereof.

As the height of the dielectric partition increases, the length of the I-shaped load may decrease.

The dielectric partition may be formed to have a height that can be achieved at a point of saturation at which the length of the I-shaped load does not decrease even when the height of the dielectric partition increases.

A space around the inside conductor may be filled with a first dielectric having a first dielectric constant, and a space between the first dielectric and the I-shaped load may be filled with a second dielectric having a second dielectric constant larger than the first dielectric constant.

The surge protector may further include a frequency characteristic compensation unit, the frequency characteristic compensation unit being formed of a conductor and including a first connection coupled with the outside conductor, and a second connection coupled between the first connection and the I-shaped load and coupled with the I-shaped load so that the coupling depth of the second connection with the I-shaped load can be adjusted.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B illustrate the schematic structures of L-shaped resonant filters;

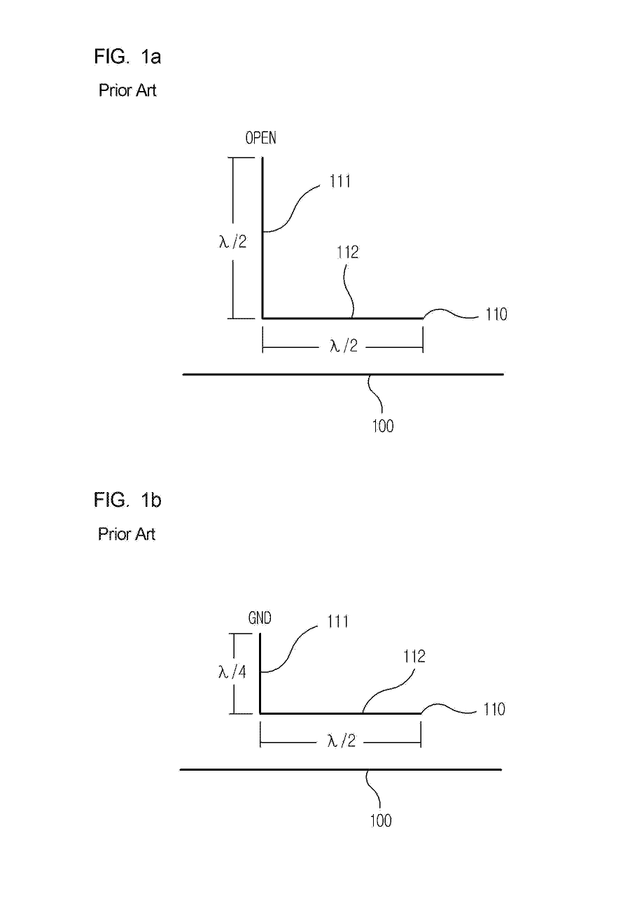

FIG. 2 illustrates an example of a surge protector using a conventional I-shaped load structure;

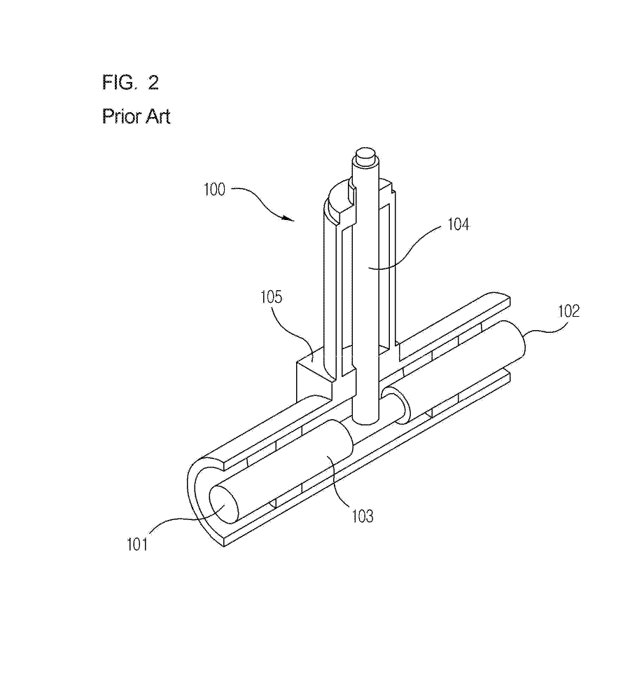

FIG. 3 is a sectional view illustrating the configuration of a surge protector having an improved I-shaped load structure according to a first embodiment of the present invention;

FIG. 4 is a graph illustrating the relationship between the height a dielectric and the length of an I-shaped load; and

FIG. 5 is a sectional view illustrating the configuration of a surge protector having an improved I-shaped load structure according to a second embodiment of the present invention.

### DESCRIPTION OF THE PREFERRED EMBODIMENTS

The present invention may be embodied in many different forms without departing from the spirit and significant characteristics of the invention. Therefore, the embodiments of the present invention are disclosed only for illustrative purposes and should not be construed as limiting the present invention.

It will be understood that, although the terms first, second, etc. may be used herein to describe various elements, these elements should not be limited by these terms.

These terms are only used to distinguish one element, from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments of the present invention will be described in detail with reference to the attached drawings. The same reference numerals will be used throughout the different drawings to designate the same or similar components, and the repetition of the same explanation for these components will be skipped.

If in the specification, detailed descriptions of well-known functions or configurations would unnecessarily obscure the gist of the present invention, the detailed descriptions will be omitted.

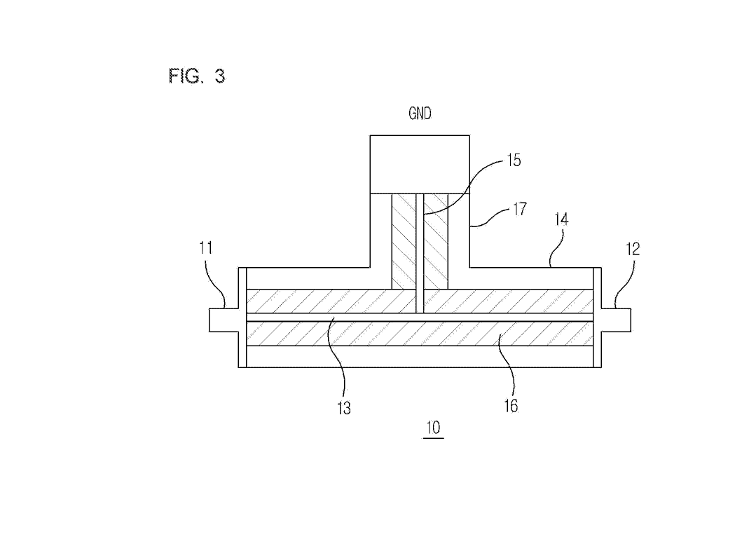

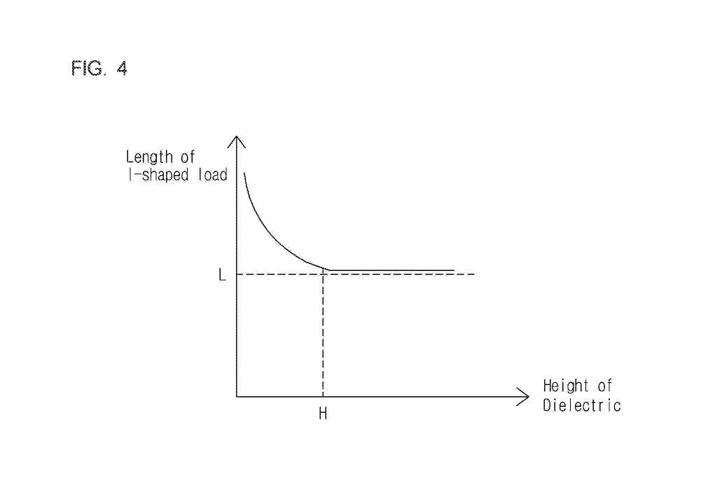

FIG. 3 is a sectional view illustrating the configuration of a surge protector having an improved I-shaped load structure according to a first embodiment of the present invention, and FIG. 4 is a graph illustrating the relationship between the height a dielectric and the length of an I-shaped load.

As illustrated in FIG. 3, the surge protector having an improved I-shaped load structure according to the first embodiment includes an outside conductor 14 provided with input and output terminals on both sides thereof, an input terminal 11 configured such that a high frequency signal is input from the outside thereto, an output terminal 12 configured such that a high frequency signal is output therefrom, an inside conductor 13 disposed inside the outside conductor 14 to electrically connect the input and output terminals to each other, and an I-shaped load 15 configured such that the lower end thereof is connected from the center of the outside conductor 14 to the inside conductor 13 and the upper end thereof is connected to the outside conductor 14.

A space around the inside conductor 13 is filled with a first dielectric 16 having a first dielectric constant, and a dielectric partition 17 filled with a second dielectric is formed around the I-shaped load 15 above the first dielectric 16.

The dielectric partition 17 is formed to have a predetermined height in a direction from the bottom of the I-shaped load 15 to the top thereof.

Based on the results of a plurality of experiments, the inventor became aware of the fact that as the height of the dielectric partition 17 was increased, the effect of extending the I-shaped load 15 became higher. This means that as the height of the dielectric partition 17 is increased, the length of the I-shaped load 15 can be decreased.

That is, for example, if the I-shaped load 15 is formed to have a length of a ¼ wavelength, it is possible to achieve the effect of a 1 wavelength almost without any insertion loss.

However, as can be seen from the graph of FIG. 4 illustrating the relationship between the height of the dielectric and the length of the I-shaped load, a point of saturation at which the effect of extending the I-shaped load 15 is not increased even when the height of the dielectric partition 17 is increased is generated. Accordingly, if the dielectric partition 17 is formed to have height h corresponding to the point of saturation and the I-shaped load 15 is formed to have corresponding length L, an optimum effect can be achieved.

The graph of FIG. 4 may vary depending on the dielectric constant of the dielectric partition 17. As the dielectric constant of the dielectric partition 17 increases, the curve of the graph moves further downward.

That is, as the dielectric constant of the dielectric partition 17 becomes higher, the length L of the I-shaped load 15 corresponding to the height of the dielectric partition 17 at a point of saturation becomes shorter. Accordingly, a surge protector having excellent surge frequency blocking performance can be implemented even using a very short I-shaped load 15.

As a result of experiments, when the dielectric constants of the first and second dielectrics were set to the same value of 2.2 and the dielectric partition 17 was formed to a height corresponding to a point of saturation, the effect of a 1 wavelength could be achieved using an I-shaped load 15 having a length of a ¼ wavelength almost without any insertion loss.

Furthermore, when dielectrics in which the dielectric constant of a second dielectric is higher than the dielectric constant of the first dielectric are used using the characteristics of the graph of FIG. 4, a surge protector having excellent performance can be implemented even using an I-shaped load 15 having a very short length.

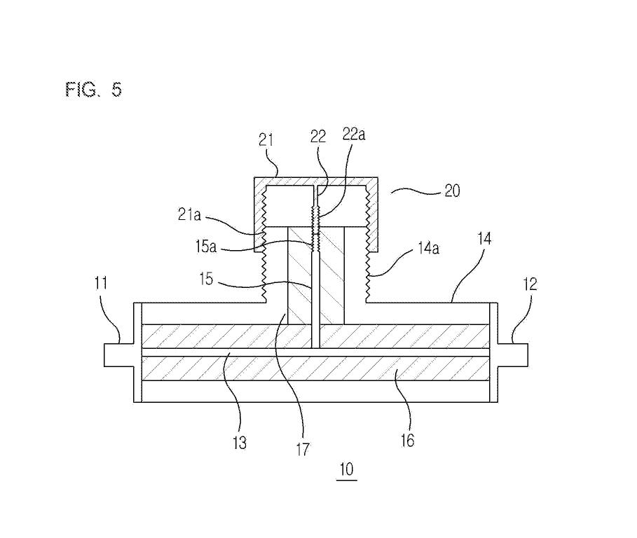

FIG. 5 is a sectional view illustrating the configuration of a surge protector having an improved I-shaped load structure according to a second embodiment of the present invention.

The effect of the extension of an I-shaped load 15 can be achieved by means of a dielectric partition 17 as in the first embodiment. However, if the length of the I-shaped load 15 is reduced even when the dielectric partition 17 is formed, resonance characteristics are weakened and thus the bandwidth is widened.

Accordingly, the second embodiment is characterized in that a frequency characteristic compensation unit 20 for compensating for the weakened frequency characteristics is further included.

The frequency characteristic compensation unit 20 is formed of a conductor. The frequency characteristic compensation unit 20 includes a first connection 21 coupled with an outside conductor 14, and a second connection 22 coupled between the first connection 21 and an I-shaped load 15 and configured to extend the length of the I-shaped load 15.

In the second embodiment, coupling means that are used to be coupled with the first and second connections 21 and 22 are formed on an outside conductor 14 and the I-shaped load 15. In the following description, screw coupling means will be illustrated as an example of the coupling means.

The first connection 21 is configured in the form of a cap having an open bottom. Screw threads 21a are formed on the inner circumferential surface of the first connection 21, and are engaged with screw threads 14a that are formed on the outer circumferential surface of the center protrusion of the outside conductor 14.

The second connection 22 protrudes from the center of the bottom of the first connection 21. Screw threads 22a are formed on the outer circumferential surface of the second connection 22, and are engaged with screw threads 15a that are formed on the inner circumferential surface of the I-shaped load 15.

Accordingly, the coupling depth of the second connection 22 and the I-shaped load 15 varies depending on the direction in which the first connection 21 is rotated, thereby varying the height of the I-shaped load 15. That is, the weakened resonance characteristics can be compensated for by minutely adjusting the coupling depth of the second connection 22 and the I-shaped load 15.

Furthermore, the resonance frequency may be varied through the adjustment of the coupling depth of the frequency characteristic compensation unit 20. The surge protector according to the second embodiment is advantageous in that it may be used as a surge protector for a plurality of frequency bands by adjusting the coupling depth of the frequency characteristic compensation unit 20 in accordance with a desired frequency band.

Although the screw coupling means has been described as coupling depth adjusting means in the above description, it will be apparent that other various types of coupling depth adjusting means may be employed.

The present invention has the advantage of achieving compactness of the surge protector because the surge protector having almost no insertion loss and high surge blocking performance can be implemented using the short-circuit load having a very short length.

Furthermore, the prevent invention has the advantage of compensating for resonance frequency characteristics because the length of the short-circuit load can be minutely adjusted.

Furthermore, the prevent invention has the advantage of being applied to a pulse current injection (PCI) protector that also functions as a surge protector because it can be applied to high frequency signals in various frequency bands through the adjustment of the length of the short-circuit load.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A surge protector having an improved I-shaped load structure, comprising:
an outside conductor provided with input and output terminals on both sides thereof;
an input terminal configured such that a high frequency signal is input from the outside thereto;
an output terminal configured such that a high frequency signal is output therefrom;
an inside conductor disposed inside the outside conductor to electrically connect the input and output terminals to each other; and
an I-shaped load configured such that a lower end thereof is connected from a center of the outside conductor to the inside conductor and an upper end thereof is connected to the outside conductor;
wherein a dielectric partition is formed to have a predetermined height in a direction from a bottom of the I-shaped load to a top thereof.

2. The surge protector of claim 1, wherein as a height of the dielectric partition increases, a length of the I-shaped load decreases.

3. The surge protector of claim 2, wherein the dielectric partition is formed to have a height that can be achieved at a point of saturation at which the length of the I-shaped load does not decrease even when the height of the dielectric partition increases.

4. The surge protector of claim 1, wherein a space around the inside conductor is filled with a first dielectric having a first dielectric constant, and a space between the first dielectric and the I-shaped load is filled with a second dielectric having a second dielectric constant larger than the first dielectric constant.

5. The surge protector of claim 1, further comprising a frequency characteristic compensation unit, the frequency characteristic compensation unit being formed of a conductor and including a first connection coupled with the outside conductor, and a second connection coupled between the first connection and the I-shaped load and coupled with the I-shaped load so that a coupling depth of the second connection with the I-shaped load can be adjusted.
